(19) United States
(12) Patent Application Publication
(10) Pub. No.: US 2002/0091647 A1
(43) Pub. Date: Jul. 11, 2002

(54) Security system for commercial transactions via the Internet or other communications networks

(76) Inventors: Antonio Vazquez Lopez, Madrid (ES); Jesus Antonio Azagra Madejon, Madrid (ES)

Correspondence Address: Vincent J. Gnoffo, Brinks Hofer Gilson & Lione, NBC Tower, Suite 3600, P.O. Box 10395, Chicago, IL, 60610, US

(21) Appl. No.: 09/998,251

(22) Filed: Nov. 30, 2001

(30) Foreign Application Priority Data
Jan. 10, 2001 (ES) P200100061

(51) Int. Cl. G06F 17/60

(52) U.S. Cl. 705/67

(57) ABSTRACT

The system and method are designed to enable the user or purchaser to avoid having to enter the user's bank information, specifically credit card information, over the Internet network. The system and method include using the user's telephone service provider or an intermediary finance company, as a “bridge” between the user and the company supplying the product or service purchased. When the purchase is made the information provided by the user is compared with the data the telephone company has on record. If the information coincides, the purchase is accepted and a cost is charged to the account the user has with the phone company. Thus, payment for the product or service is made along with payment for regular telephone service on the bill for the phone service. The phone company pays the supplier once the user or subscriber pays the phone company.

### FIELD OF THE INVENTION

This invention refers to a security system designed for the area of electronic commerce, to lessen the risks to purchasers of the form of payment for purchases made through the Internet or other communications networks from the standpoint of avoiding the loss of confidentiality of their information and the risk that it might be used by third parties to make fraudulent purchases.

Thus, the invention eliminates the problem that commercial transactions via the Internet or other communications networks currently pose.

### BACKGROUND

Within the extremely broad range of capabilities offered by the Internet or other communications networks, one of the most important ones with one of the brightest futures is electronic commerce, as it allows users of the system to access highly detailed information about the products or services they are interested in, conveniently and from their own homes, and to select any product or service and have it delivered, also right to their homes.

However, in opposition to these obvious and significant advantages of electronic commerce is the fundamental problem of a lack of security, as in a commercial transaction of this type, both company and user data are involved, and anyone with enough knowledge is in a position to access this information and use it in a wrongful manner.

Apart from losses to companies that run into the millions, this produces a generalized lack of trust at the client or user level, which considerably limits this commercial system.

Currently, the only alternatives available to credit-card payment, which generates the aforementioned lack of security, consist of making an advance transfer, which means a slow process with costs involved to the user, or else shipping the product COD, which in addition to being slow also increases the cost to the supplier.

### SUMMARY

The security system proposed by the invention solves the aforementioned problem, allowing a quick, effective and secure transaction. This system is based on using the telephone service provider or an intermediary finance company in agreement with the telecommunication operator—“the service operator”—that the user uses for the Internet or other communications networks as a billing “bridge” between the company supplying the product and the user or consumer, so that the company's products or services are charged to the telephone bill that the purchaser or user will receive from his telephone company or the service operator chosen.

More specifically, a computer program collects all user data, checks to see whether it coincides with data received from the service operator in order to accept or reject the purchase, and sends it to the supplier company. The receipt, encryption and sending of data will be the task of the company that provides telephone or telecommunication service, which may be a any kind of commercial entity, i.e. telephone company, electricity company, television or media company, finance company in agreement with a telecommunication operator with the purpose of providing this service, etc.

Thus, the purchaser or user does not reveal his bank information to anyone other than to the company who supplies the communication line or to his finance company, which already has this information, and security is determined by the fact that the purchaser or user, when making a purchase, must confirm it by phone from his own subscriber telephone number.

The system even allows the capability of making urgent purchases from a telephone not related to the purchaser or user, for example, from a pay phone, as long as the purchase is confirmed from the purchaser's own number within a pre-determined period, such as, for example, within 24 hours.

### DESCRIPTION OF THE DRAWINGS

To complement this description and for the purpose of allowing for better understanding of the characteristics of the invention, in accordance with an example of its preferred embodiment, a set of drawings of an illustrative and non-restrictive nature, in which the following items are represented, is attached as an integral part of this description:

FIGS. 1A-1C represent a flow diagram corresponding to putting the security system for commercial transactions via the Internet or other communications networks, which is the purpose of this invention, into operation.

FIGS. 2-14 show the on-screen representation of the different phases of the flow diagram from the preceding claim.

### PREFERRED EMBODIMENTS

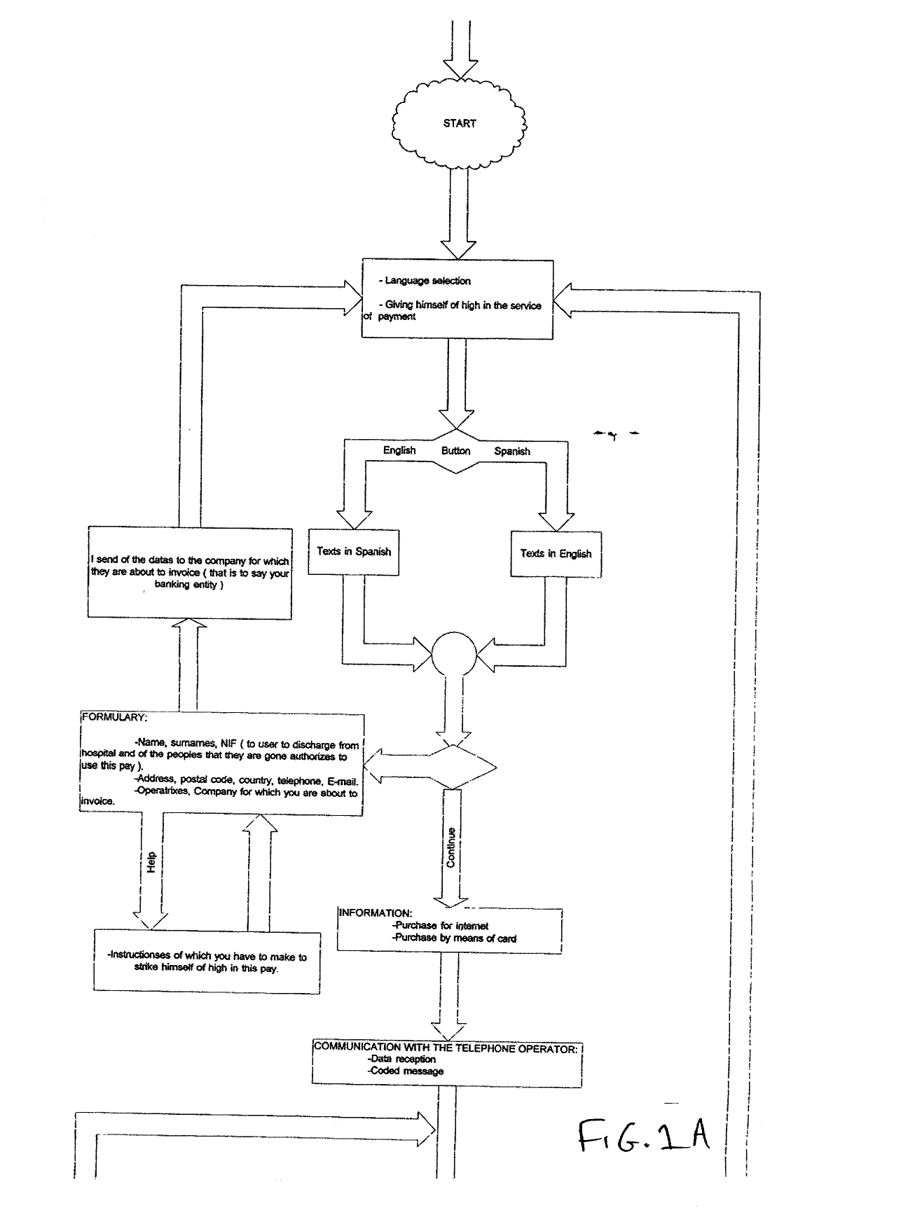

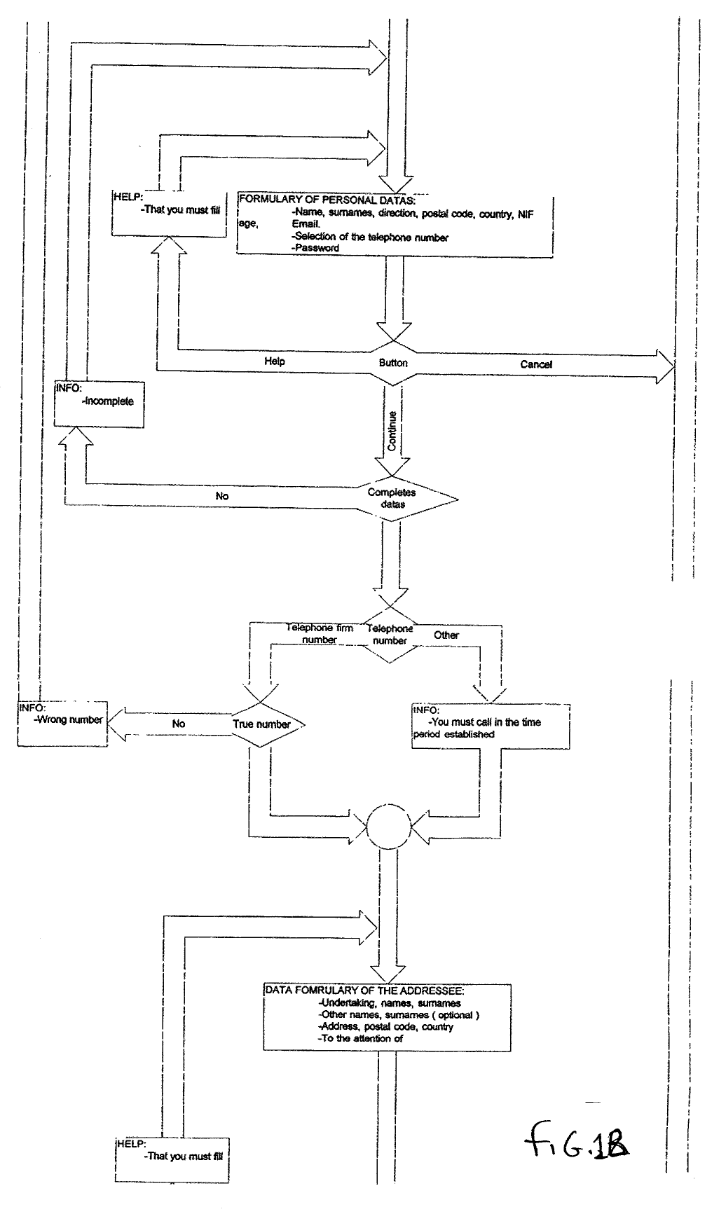

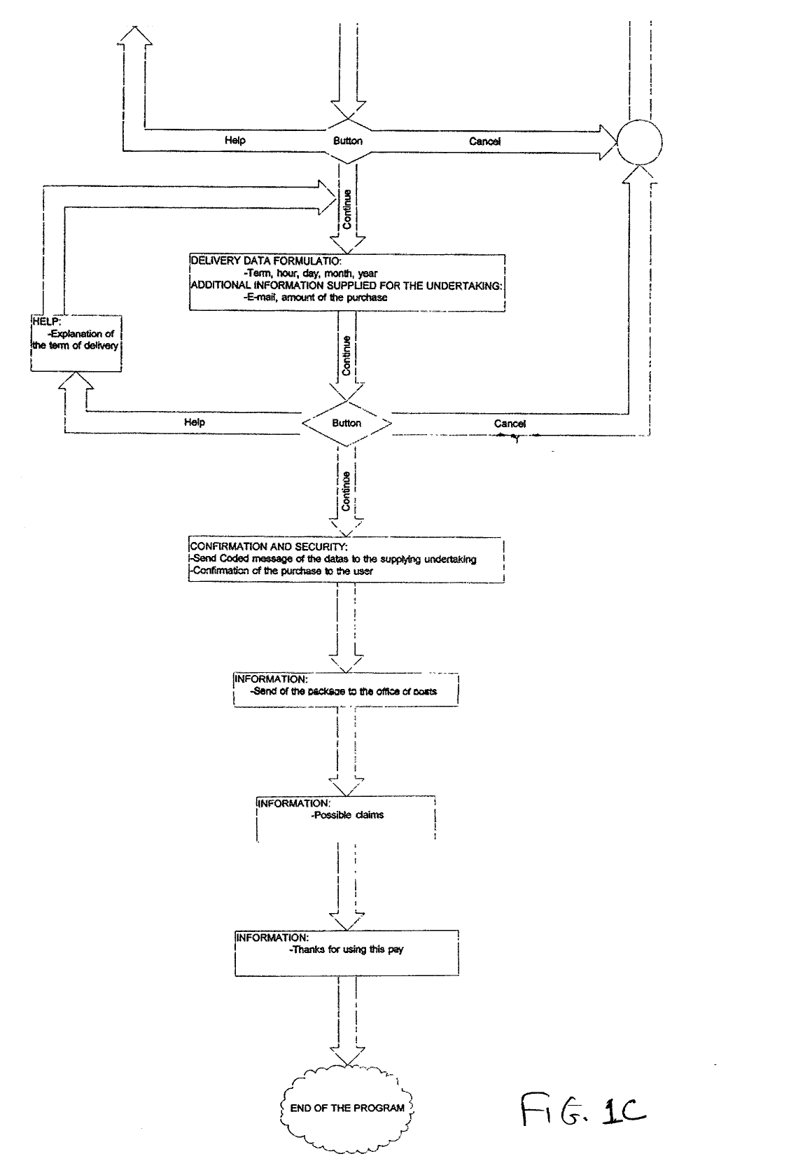

In light of the aforementioned figures and in particular of the flow diagram in FIG. 1, it can be seen that after the start, a dialog is established in which the user is asked to select a language, so that through the use of a button, option is accessed for texts in Spanish, or option for texts in English, or any other language, where appropriate.

Next, the user is informed of the possibility of using the same remote purchase service by means of a card accepted at authorized establishments.

In the next stage of the program, communication is established with the operator service provider to receive from it the information regarding the subscriber number from which the call has been made and that subscriber's personal information, for later verification.

Next, the user must fill in the form in which he is asked for his personal information: name, surname(s), address, postal code, country, age, tax ID no., e-mail address (the latter is optional) and user password, as well as to determine whether he is making the call from his own phone number or from another number. He will also be asked for an identifying password.

At this point, the user has the option, using button, to request help, to cancel the program, or to proceed.

If he chooses to continue, the program checks to make sure that all data is complete, in other words, that the user has filled in all fields on the form; otherwise, through the return the user will once again be taken to the aforementioned form, so that it can be filled in properly.

If everything is as it should be and the user is placing the call from a telephone corresponding to his own subscriber number and password, the program compares the information with the data received from the service operator provider, in order to accept or reject the purchase. If the data coincides, the purchase is approved and the program continues; if not, i.e., if the data does not coincide, the program returns the user to the previous form, informing him of the error that has occurred.

If the user is placing the call from a number other than his own phone number, the program will check to make sure that he has entered his number, and if so, will inform him that he must call from his own phone number within a predetermined period of 24 hours to confirm the purchase.

The user is then taken to a form for consignee information, in which the user must fill in the data for the company or person(s) authorized to receive the purchase, as well as the consignee's address, postal code, country, and to whose attention the shipment is to be sent. The program uses the personal information from the initial form as a default setting for filling in this form.

At this point, the user once again has the option, through button, to request help, to cancel or to proceed. If he requests help, a window will be displayed in which the program will explain how the requested data must be filled in. If he decides to cancel, the program returns to the personal information form, and if he decides to continue, the program saves the user's data and goes on to the next form, which corresponds to delivery information; here the user must fill in the data corresponding to the lead time, time of day, day, month and year for the delivery of the purchase. In addition, he will receive further information from the supplier company, such as its e-mail address and the total amount, including tax, of the purchase made.

At this time, the user once again has the option to request help through button, help consisting of an explanation of the lead time; to cancel, in which case the program returns to the consignee information form; or to continue, in which case the program sets up communication with the supplier company, sending the user's encrypted data, confirming that user's purchase.

Later, the application informs the user of the possibility that the shipment may be sent to the post office nearest to the consignment address, if no one authorized to receive the shipment is present at the designated place when delivery is attempted, and finally, the user is informed that filing a claim is possible, and the application ends by thanking the user for having used this service.

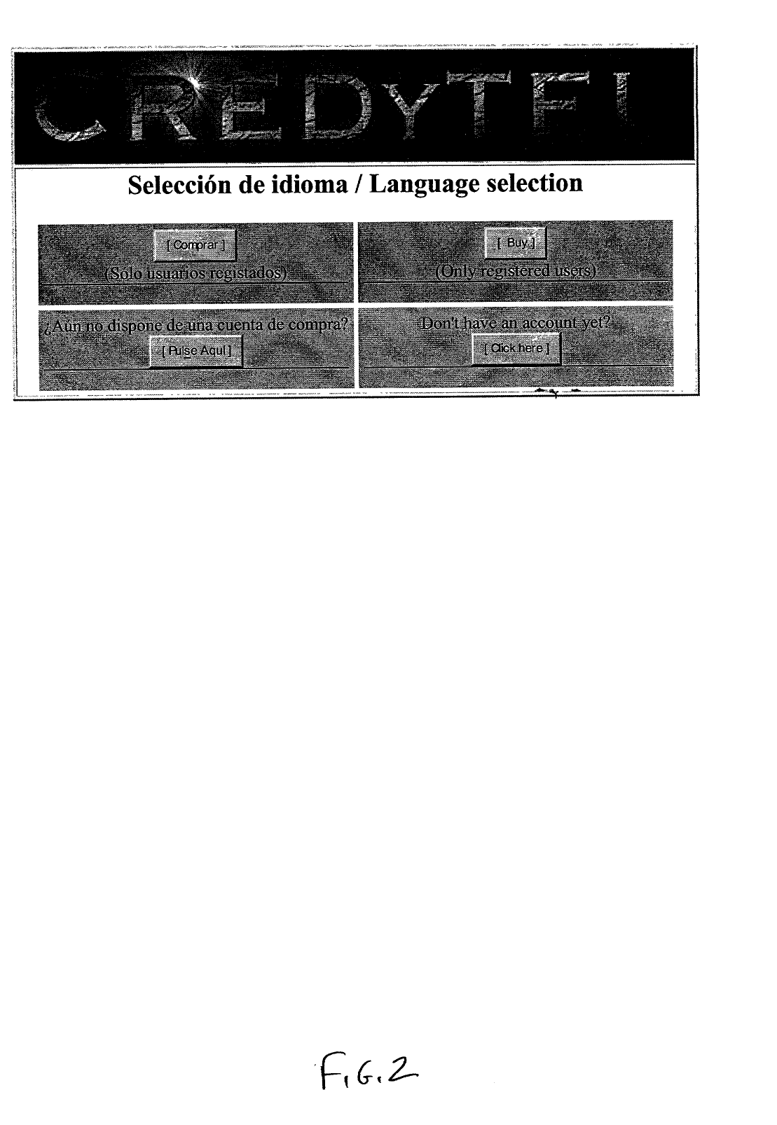

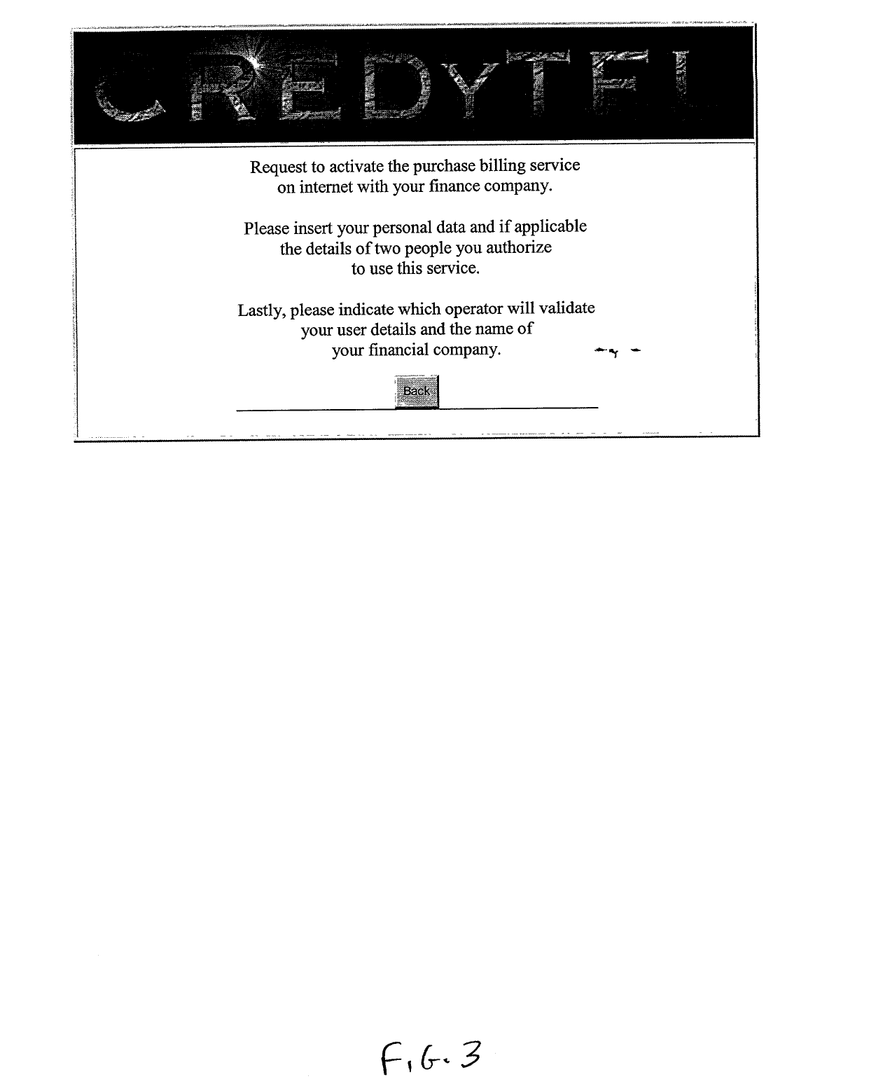

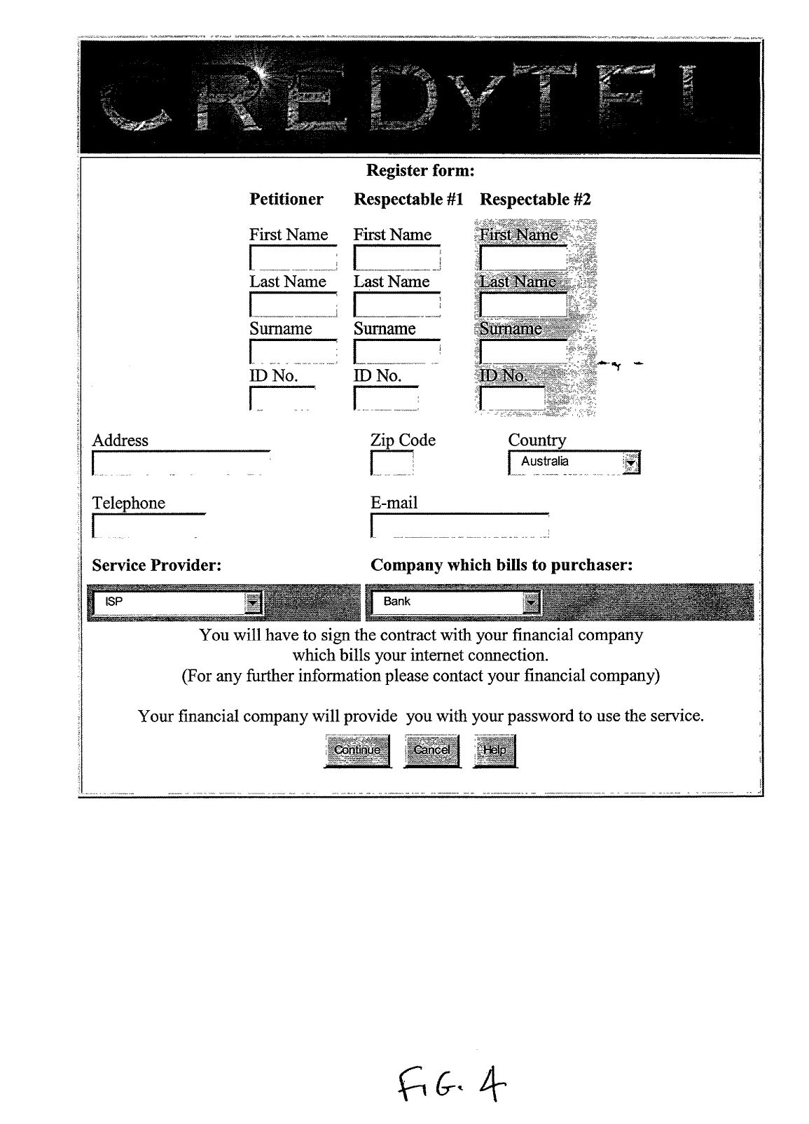

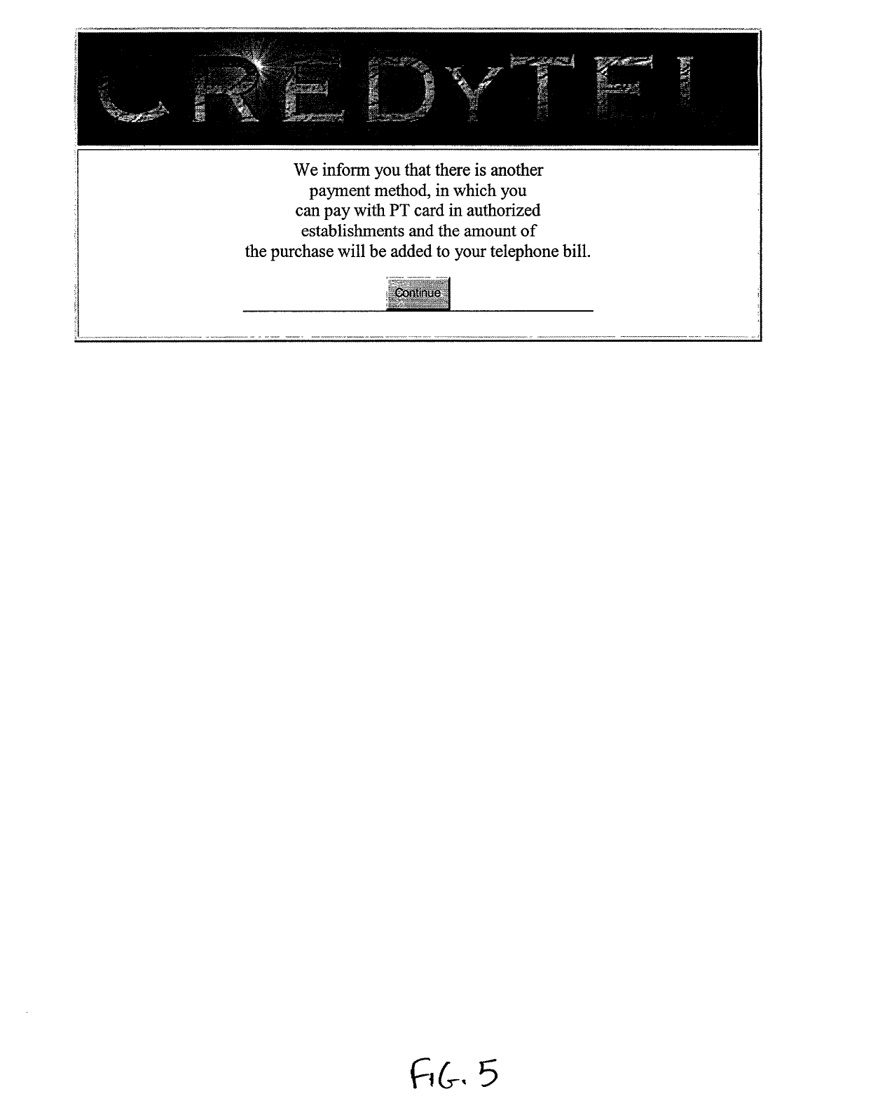

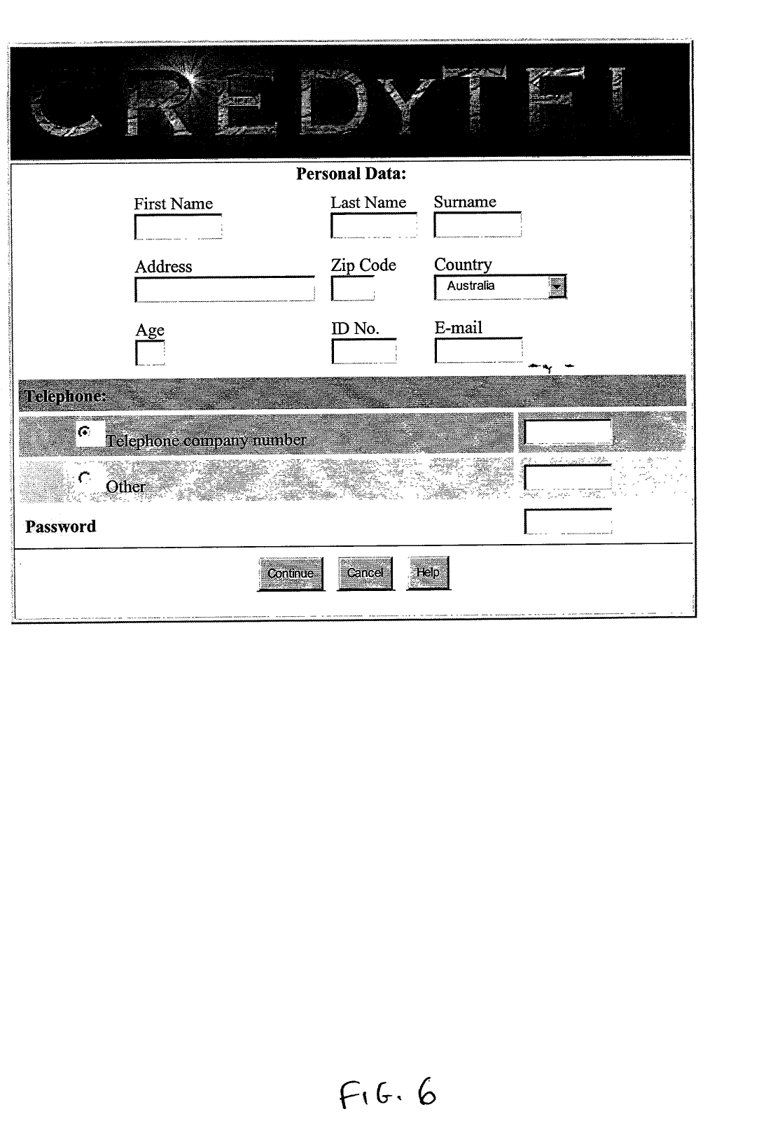

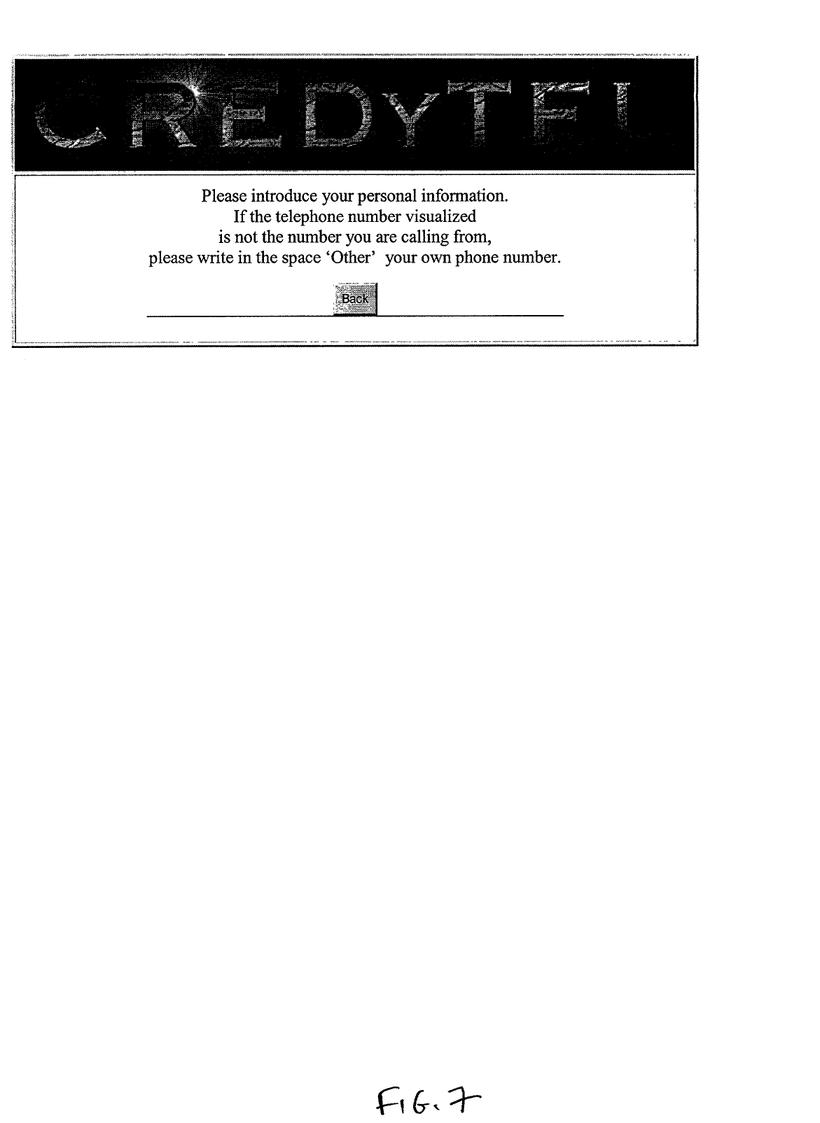

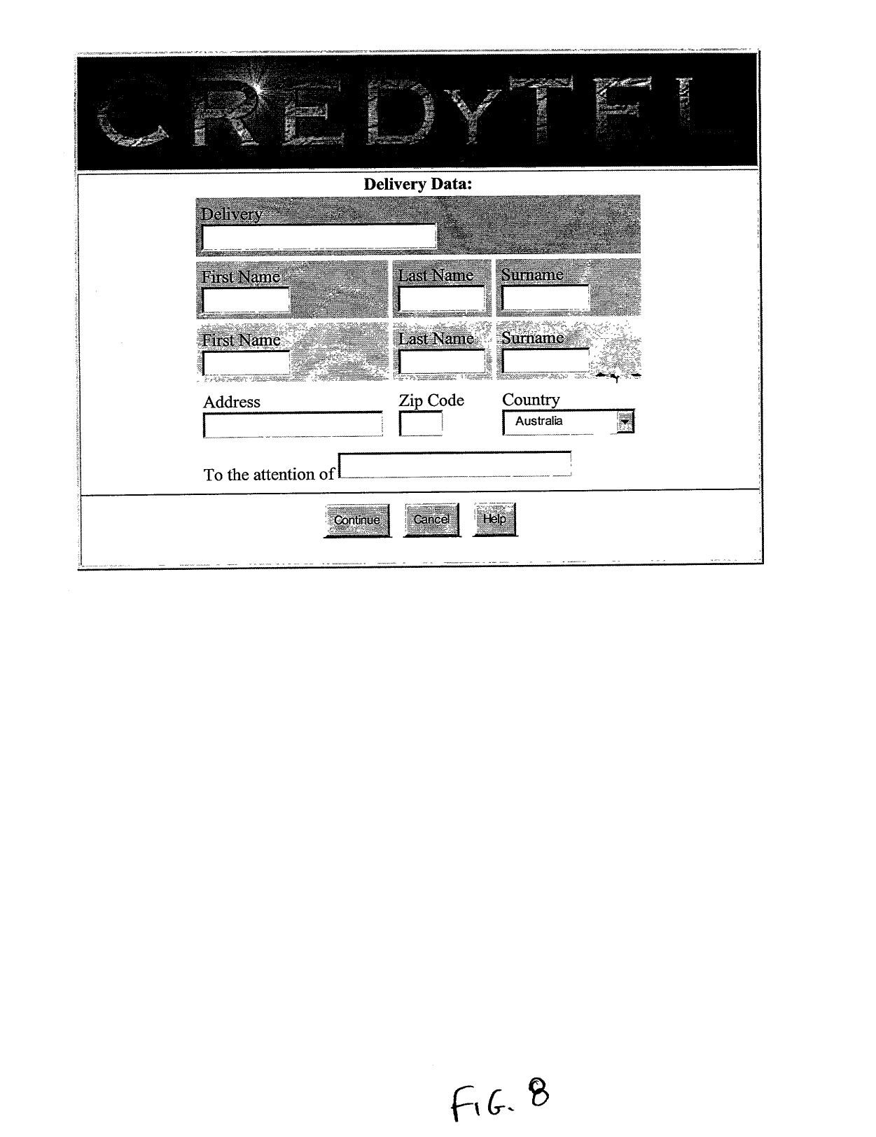

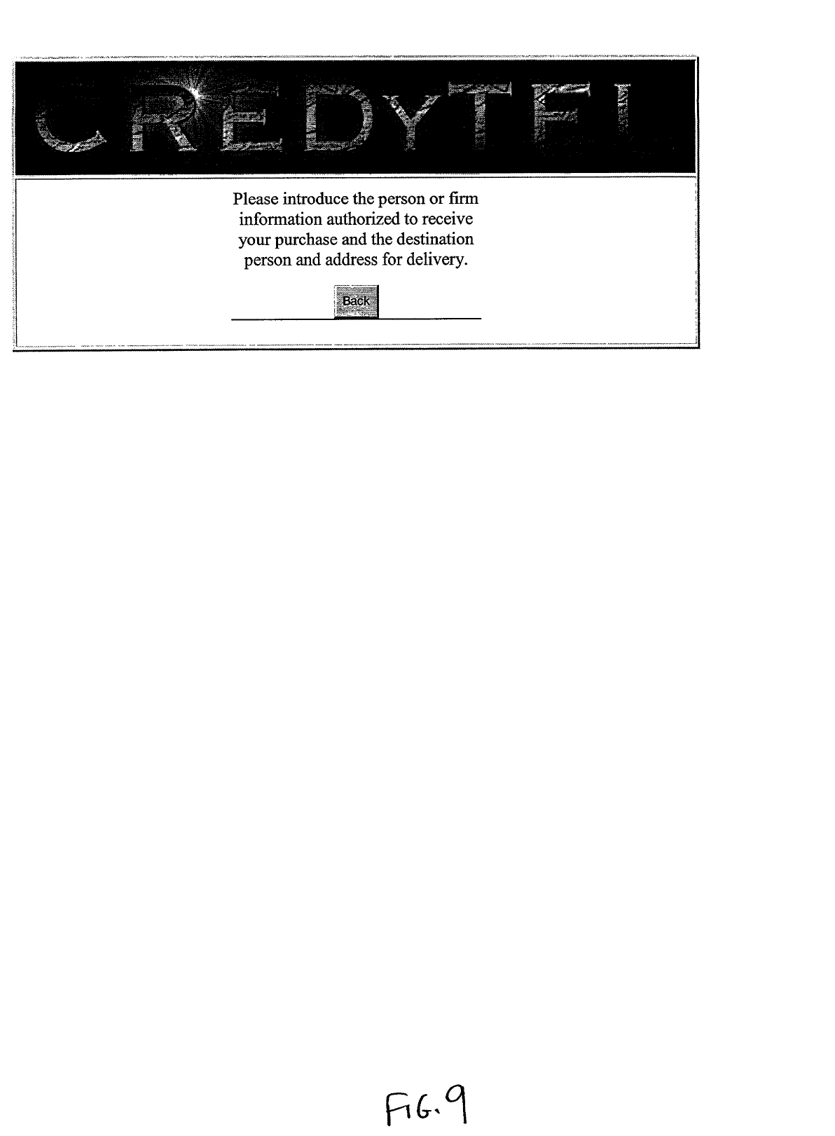

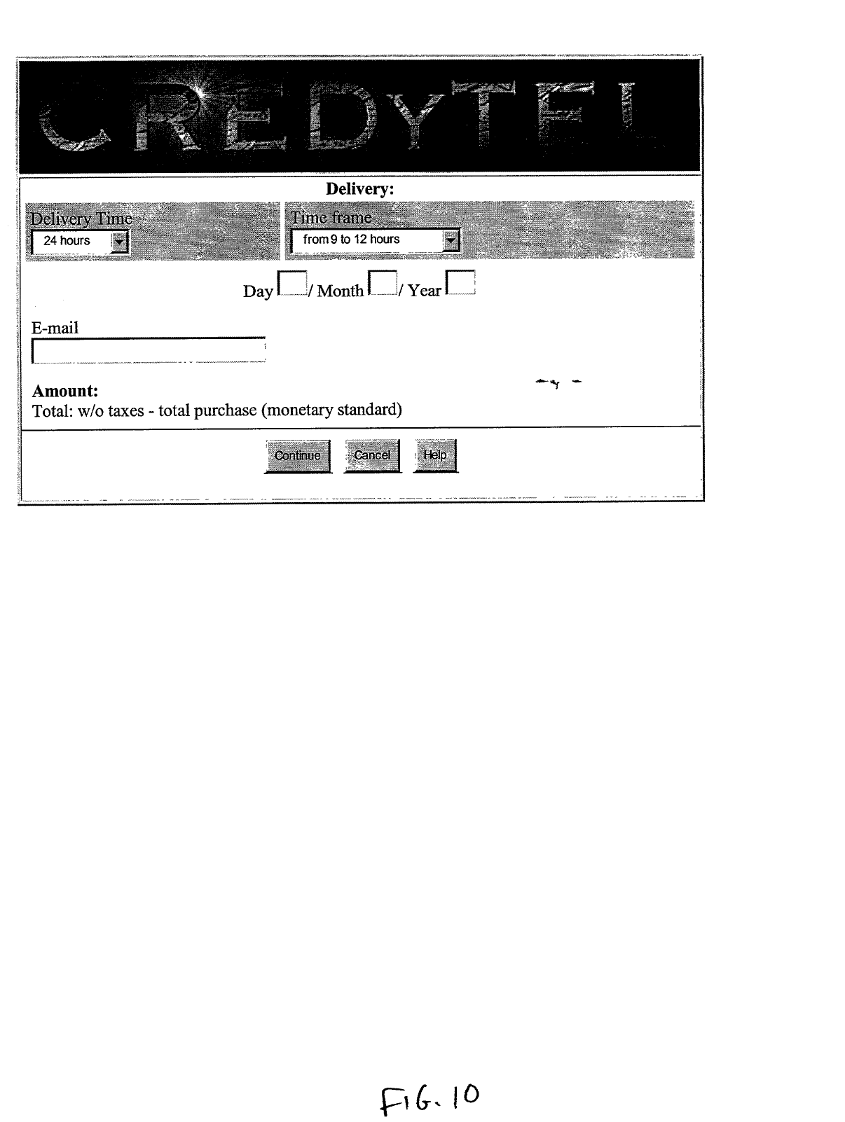

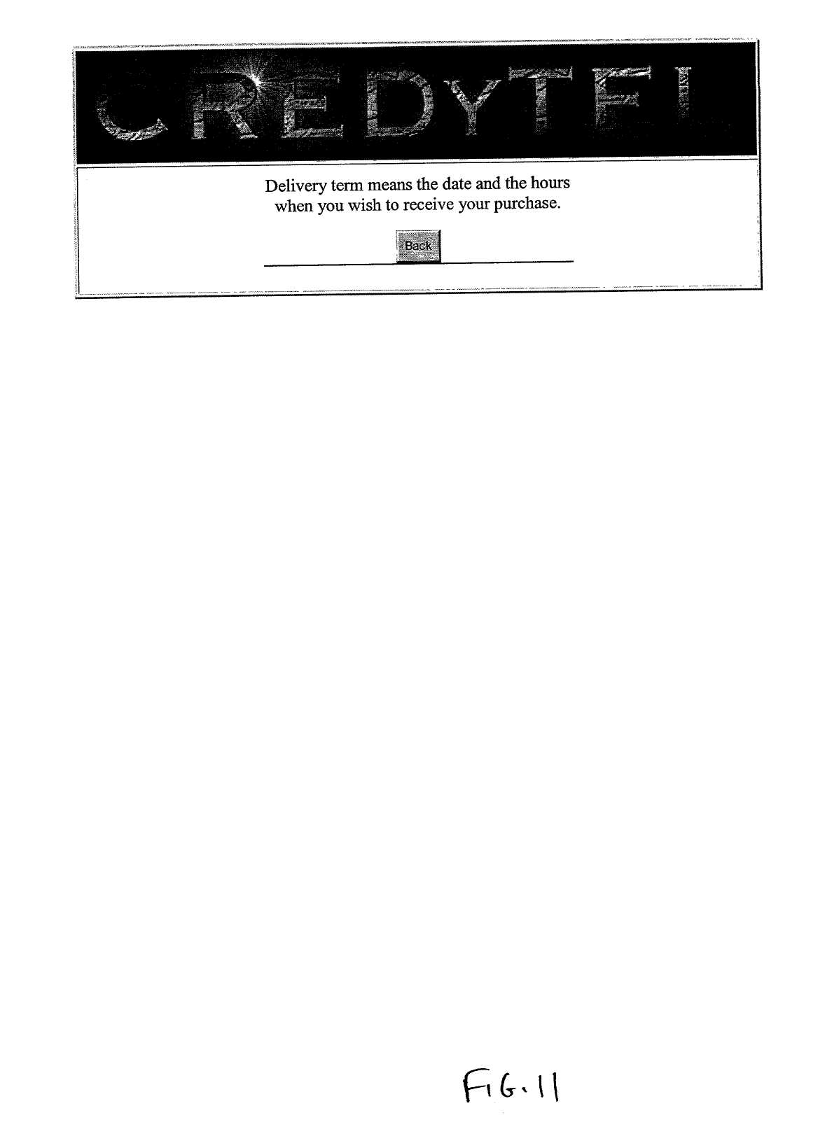

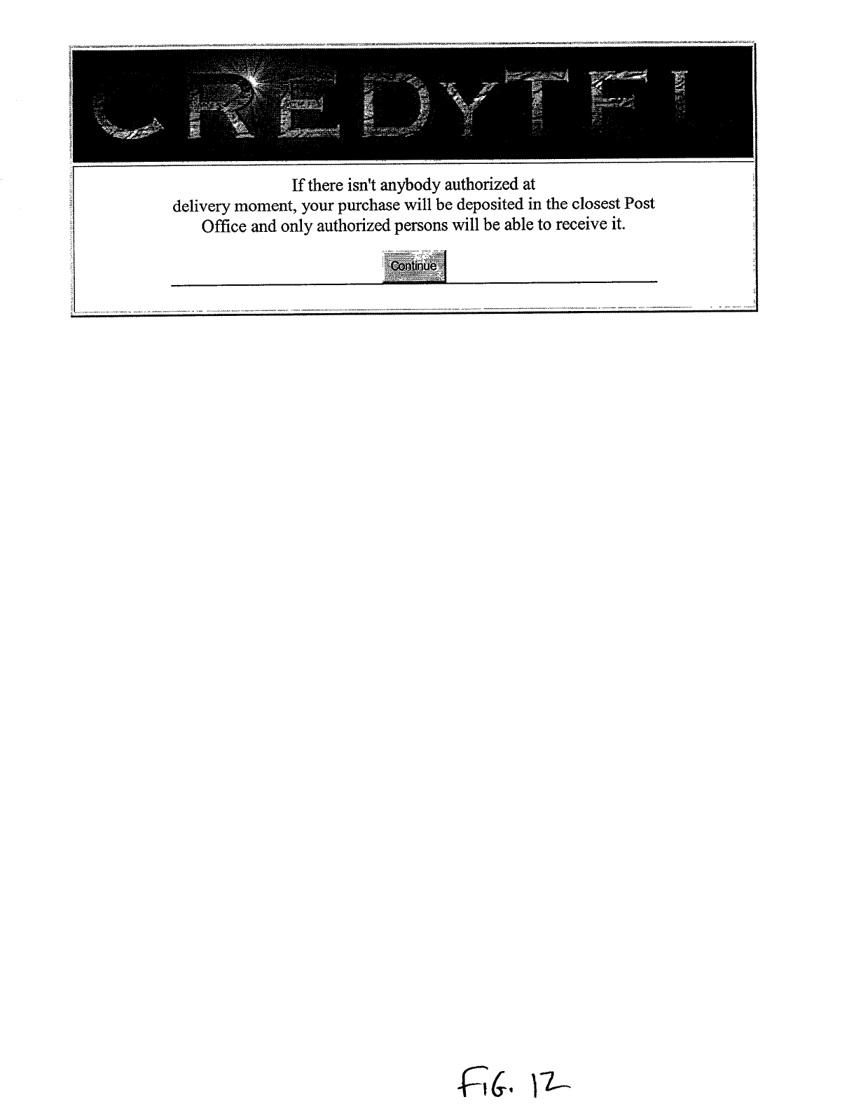

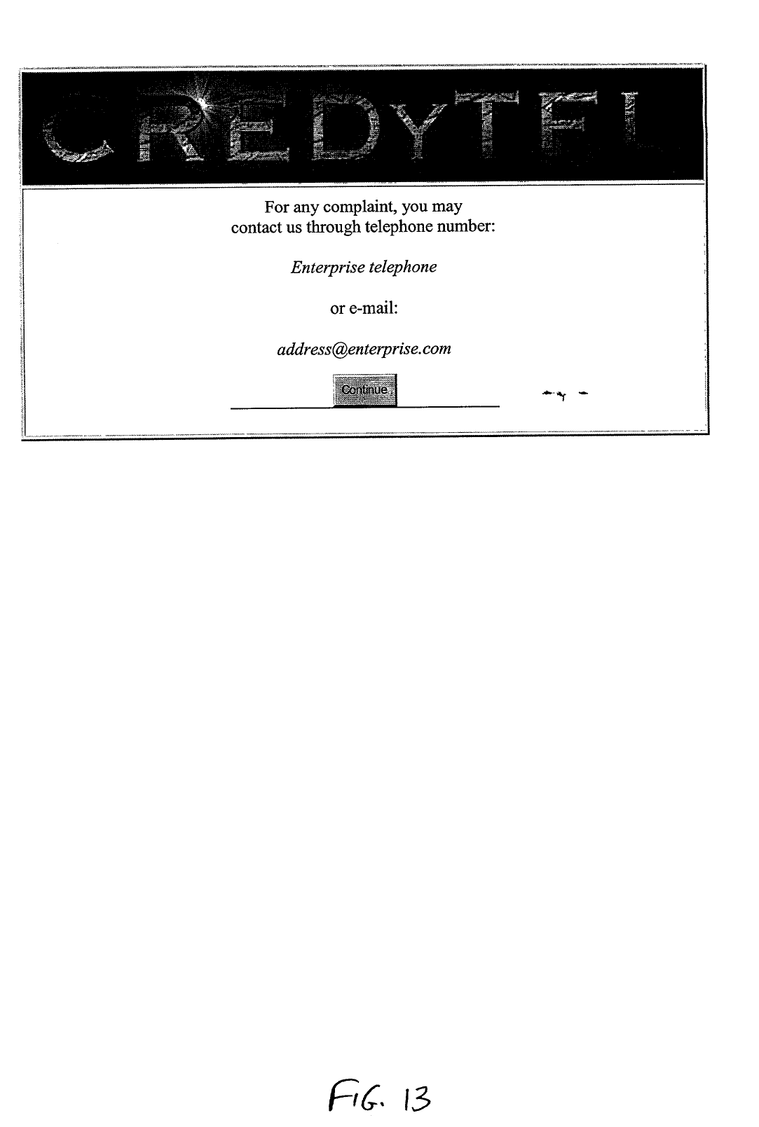

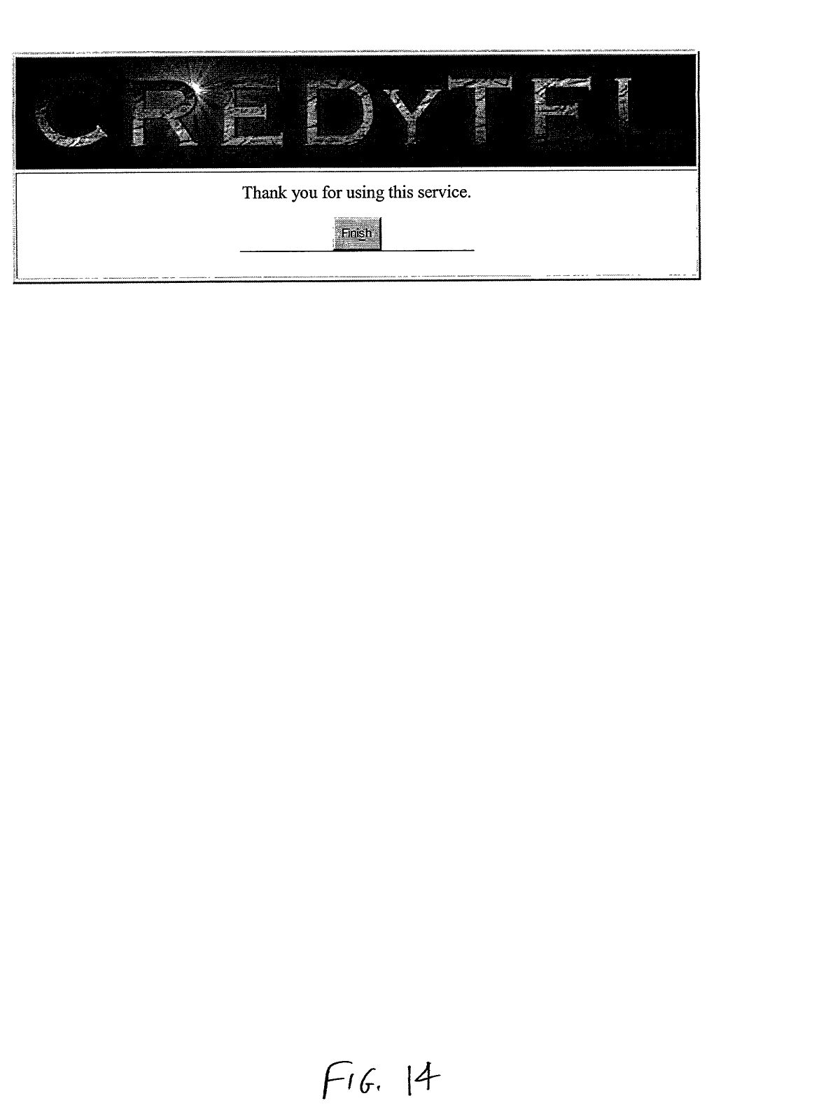

The different sequences in FIGS. 2-14 show an on-screen graphic representation of the different stages of the flow diagram described and represented in FIGS. 1A-1C.

The foregoing detailed description should be regarded as illustrative rather than limiting and the appended claims, including all equivalents, are intended to define the scope of the invention.

1. Security system for commercial transactions via the Internet or other communications networks, whose purpose is to enable any user or purchaser to avoid having to enter his bank information over the network, comprising: using the user's telecommunication service provider or an intermediary finance company as a bridge element between this user and the company supplying the product or service in question, so that the user enters his personal information by filling in a form; this information is compared with the data received from the telephone or finance company, which has this information in its possession, to accept the purchase if the data coincides, or to reject it if not, so that if the purchase is accepted, it is charged to the user's phone bill or personal account, while the supplier company will collect from the aforementioned operator at a later date.

2. Security system for commercial transactions via the Internet or other communications networks, according to claim 1, wherein an application begins by asking the user to select a language to be used, from a group of languages pre-set for that purpose, following which the user is informed of the possibility of using the same remote purchase service by means of a credit card accepted at authorized establishments; if the user does not choose to pay with a card, information corresponding to the subscriber phone number from which the call was made and to the subscriber himself is received from the telephone service provider or finance company authorized to provide the service, for later verification, after which the user must fill in a form requesting his personal information, as well as information about whether he placed the call from his subscriber telephone number or from another number; in parallel, an identifying password is requested, so that once all the information has been checked and compared, with the possibility of correcting mistakes or canceling, the user goes on to a consignee data form; in this form, the user reflects the information corresponding to the place where the shipment is to be delivered, and this is followed by another form corresponding to the information about this delivery in terms of lead time, time of day, day, month and year for the delivery; next, communication is established with the supplier company, and the user's encrypted data is sent and his purchase confirmed.

3. Security system for commercial transactions via the Internet or other communications networks, according to claim 2, wherein the user places the call from a number other than his own phone number, the application, after checking to make sure that this subscriber number appears on the form, establishes a pre-determined period, for example, 24 hours, to confirm the purchase from his own phone number.
